(19) United States
(12) Patent Application Publication
(10) Pub. No.: US 2022/0341378 A1
(43) Pub. Date: Oct. 27, 2022

(54) INTERNAL COMBUSTION ENGINE SYSTEM WITH TURBOCHARGER INTERCOOLER AND EXHAUST GAS RECIRCULATION PUMP

(71) Applicant: Deere & Company, Moline, IL (US)

(72) Inventors: Scott R. Miles, Cedar Falls, IA (US); Eric J. Haaland, Waverly, IA (US); Pratir R. Punjani, Waterloo, IA (US)

(21) Appl. No.: 17/237,876

(22) Filed: Apr. 22, 2021

(51) Int. Cl. F02M 26/05; F02M 26/28

(52) U.S. Cl. CPC F02M 26/05; F02M 26/28; F02M 26/24

(57) ABSTRACT

An internal combustion engine system includes an engine block having one or more piston-cylinder arrangements communicating with an intake manifold and an exhaust manifold, a high-pressure (HP) turbocharger including an HP turbine in communication with the exhaust manifold and including an HP compressor in communication with the intake manifold, a low-pressure (LP) turbocharger including an LP turbine in communication with the exhaust manifold via the HP turbine and including an LP compressor in communication with the intake manifold via the HP compressor, an exhaust gas recirculation (EGR) system including an EGR pump upstream of the HP turbine and in communication with the exhaust manifold at an inlet side of the EGR pump and in communication with the intake manifold at an outlet side of the EGR pump, and an intercooler interposed between the LP compressor and the HP compressor.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to an internal combustion engine system and, more particularly, to an arrangement of an exhaust gas recirculation pump and turbocharger air coolers in such engine systems.

### BACKGROUND OF THE DISCLOSURE

It is common for internal combustion engine systems on many work vehicles to include one or more turbochargers that boost airflow to the engine to improve engine performance. Each turbocharger includes a turbine and a compressor, with the turbine driven by exhaust gas from the engine and the compressor, in turn, being driven by the turbine to compress air provided to the combustion chambers. To control NOx emissions, it is common to recirculate a portion of exhaust gas (EGR) and mix that exhaust gas with intake air for combustion to reduce combustion temperatures, thereby inhibiting NOx formation. The amount of exhaust gas recirculated in the engine system may be controlled by an EGR valve or EGR pump. An EGR valve may control the flow of exhaust gas for mixing with the intake air based on a pressure differential between the exhaust gas and the intake air, while an EGR pump may be selectively operated to control the flow of exhaust gas for mixing with the intake air.

### SUMMARY OF THE DISCLOSURE

An internal combustion engine system includes an engine block having one or more piston-cylinder arrangements communicating with an intake manifold and an exhaust manifold, a high-pressure (HP) turbocharger including an HP turbine in communication with the exhaust manifold and including an HP compressor in communication with the intake manifold, a low-pressure (LP) turbocharger including an LP turbine in communication with the exhaust manifold via the HP turbine and including an LP compressor in communication with the intake manifold via the HP compressor, an exhaust gas recirculation (EGR) system including an EGR pump upstream of the HP turbine and in communication with the exhaust manifold at an inlet side of the EGR pump and in communication with the intake manifold at an outlet side of the EGR pump, and an intercooler interposed between the LP compressor and the HP compressor.

In another implementation, an internal combustion engine system includes an engine block having one or more piston-cylinder arrangements communicating with an intake manifold and an exhaust manifold, a high-pressure (HP) turbocharger including an HP turbine in communication with the exhaust manifold and including an HP compressor in communication with the intake manifold, a low-pressure (LP) turbocharger including an LP turbine in communication with the exhaust manifold via the HP turbine and including an LP compressor in communication with the intake manifold via the HP compressor, an exhaust gas recirculation (EGR) system including an EGR pump upstream of the HP turbine and in communication with the exhaust manifold at an inlet side of the EGR pump and in communication with the intake manifold at an outlet side of the EGR pump, an intercooler interposed between the LP compressor and the HP compressor, and an aftercooler downstream of the HP compressor and in communication with the intake manifold.

In still another implementation, an internal combustion engine system includes an engine block having one or more piston-cylinder arrangements communicating with an intake manifold and an exhaust manifold, a high-pressure (HP) turbocharger including a HP turbine in communication with the exhaust manifold and including a HP compressor in communication with the intake manifold, and a low-pressure (LP) turbocharger including a LP turbine in communication with the exhaust manifold via the HP turbine and including a LP compressor in communication with the intake manifold via the HP compressor. The internal combustion engine system also includes an exhaust gas recirculation (EGR) system, with the EGR system further including an EGR pump upstream of the HP turbine and in communication with the exhaust manifold at an inlet side of the EGR pump and in communication with the intake manifold at an outlet side of the EGR pump, and an EGR cooler upstream of the HP turbine. The internal combustion engine system further includes an intercooler interposed between the LP compressor and the HP compressor and an aftercooler downstream of the HP compressor and in communication with the intake manifold.

The details of one or more embodiments are set-forth in the accompanying drawings and the description below. Other features and advantages will become apparent from the description, the drawings, and the claims.

### BRIEF DESCRIPTION OF THE DRAWINGS

At least one example of the present disclosure will hereinafter be described in conjunction with the following figures:

FIG. 1 is a simplified side view of an example work vehicle in which embodiments of the present disclosure may be implemented;

FIG. 2 is a schematic diagram of an example engine system having an EGR pump and intercooler in accordance with an embodiment; and

FIG. 3 is a schematic diagram of an example engine system having an EGR pump and intercooler in accordance with another embodiment.

Like reference symbols in the various drawings indicate like elements. For simplicity and clarity of illustration, descriptions and details of well-known features and techniques may be omitted to avoid unnecessarily obscuring the example and non-limiting embodiments of the invention described in the subsequent Detailed Description. It should further be understood that features or elements appearing in the accompanying figures are not necessarily drawn to scale unless otherwise stated.

### DETAILED DESCRIPTION

Embodiments of the present disclosure are shown in the accompanying figures of the drawings described briefly above. Various modifications to the example embodiments may be contemplated by one of skill in the art without departing from the scope of the present invention, as set-forth the appended claims.

### OVERVIEW

As previously noted, internal combustion engines may include one or more turbochargers that compress air that is supplied to combustion chambers within the engine to allow more air and fuel to be combusted per engine cycle and thereby increase the output of the engine. In operation of the turbocharger(s), exhaust gas produced by the engine is used to drive a turbine of the turbocharger, with exhaust gas flowing through the turbine and causing it to rotate, thereby driving a compressor of the turbocharger to output an air flow of increased density that is forced into the combustion chambers of the engine. Additionally, at least a portion of the exhaust gas may be recirculated back to the intake of the engine for mixing with intake air for combustion, with the amount of exhaust gas that is recirculated being controlled by an EGR valve or EGR pump.

In an EGR system that utilizes an EGR valve for controlling the recirculation of exhaust gas back to the engine intake, it is recognized that a pressure differential between the exhaust gas and the intake air is required for the recirculation to occur. That is, the pressure of the exhaust gas output from the engine must be higher than the pressure of the intake air supplied to the engine to create a positive pressure difference across the EGR valve that allows for the flow of exhaust gas. To increase the pressure of the exhaust gas, the size of the turbocharger turbine (i.e., size of the high-pressure turbine and/or low pressure turbine in a dual turbocharger system) is reduced, as a smaller turbine restricts the flow of exhaust gas therethrough and therefore increases the pressure of the exhaust gas on the exhaust gas side of the EGR valve. While this restricting of the turbine size enables recirculation of the exhaust gas, it reduces the efficiency of the engine system, as the smaller turbine causes higher pumping power for the engine to fill and empty the cylinders. Other engines may include variable geometry turbine technologies which can be controlled for regulating exhaust system pressures and, in turn, for driving EGR gas across the EGR valve.

In an EGR system that utilizes an EGR pump for controlling the recirculation of exhaust gas back to the engine intake, the pump may be a mechanically or electrically driven pump that draws exhaust gas therein and controllably outputs a desired amount of exhaust gas. In existing arrangements, the EGR pump is located downstream of one or more of the turbocharger turbines—i.e., downstream of both the high pressure (HP) and low pressure (LP) turbines in a dual turbocharger system, between the HP and LP turbines in a dual turbocharger system, or downstream of the turbine in a single turbocharger system. At one of these indicated locations, the EGR pump draws in a portion of the exhaust gas and then outputs a controlled amount of exhaust gas for mixing with the intake air. The mixture of the exhaust gas and intake air is then routed through one or more of the turbocharger compressors and one or more air coolers (intercooler and/or aftercooler) before being fed back to the intake of the engine.

While effective for recirculating exhaust gas in the engine system, the positioning and connection of the EGR pump within the EGR system in the manner described above is recognized as introducing certain system inefficiencies and component degradation concerns. For example, where the EGR pump is located downstream of one or both of the HP and LP turbines (or downstream of a single turbine), the exhaust gas provided to the pump is at a lower pressure after passing through the turbine(s). The EGR pump thus requires more energy to bring the exhaust gas back up to a desired pressure that matches the pressure of the intake air with which it is mixed. Additionally, the addition of the exhaust gas output from the EGR pump into the intake air at a location upstream from one or more of the turbocharger compressors, and the subsequent routing of the mixed intake air and exhaust gas through the compressor(s), necessitates an increase in the amount of work performed by the compressor(s) or an increase in the sizing of the compressor(s) in the engine system for accommodating such fluid flow. For example, where a compressor configured to perform compression on 100 units of flow of intake air is forced to also perform compression on 30 units of flow of exhaust gas, the amount of work performed by the compressor and/or the sizing of the compressor must be increased, which negatively impacts power and efficiency metrics in the engine system. Still further, it is known that the exhaust gas includes an increased amount of water vapor therein as compared to the ambient intake air with which it is mixed, and when this exhaust gas is compressed and cooled by the turbocharger compressor(s) and cooler(s), the water vapor condenses and collects within the compressor(s) and cooler(s). This water, in combination with other acids and particulates (i.e., soot) in the exhaust gas, can prematurely corrode the compressor(s) and cooler(s) and decrease the lifespan thereof.

To address the issues of system inefficiencies and component degradation present with existing EGR systems within an internal combustion engine system, including existing uses and arrangements of an EGR valve or EGR pump, an engine system is disclosed that includes an EGR system that provides for improved fuel efficiency and component longevity. The EGR system is separated from the turbocharger assembly (HP and LP turbochargers) and associated coolers of the engine system, such that an EGR pump included in the EGR system directs a portion of the exhaust gas produced by the engine directly back to the engine intake without being routed through the turbochargers and associated coolers in the engine system. The EGR pump draws exhaust gas from a location upstream of the HP turbocharger, so that the amount of work performed by the EGR pump to bring the exhaust gas to a pressure that matches that of the intake air provided to the engine is reduced.

The engine system also includes an intercooler between the HP compressor and LP compressor of the turbochargers to provide inter-stage cooling to intake air that is provided to the engine. The interstage cooler may be an air-air heat exchanger that cools intake air that is output from the LP compressor prior to the intake air being further compressed by the HP compressor, thereby increasing the density of the intake air to improve the efficiency of the HP compressor. The increased efficiency provided by inclusion of the intercooler, in combination with use of the EGR pump to provide a forced recirculation of exhaust gas to the engine, increases the efficiency (i.e., fuel efficiency or brake-specific fuel consumption (BSFC)) of the engine system by a significant amount as compared to existing engine systems that utilize EGR.

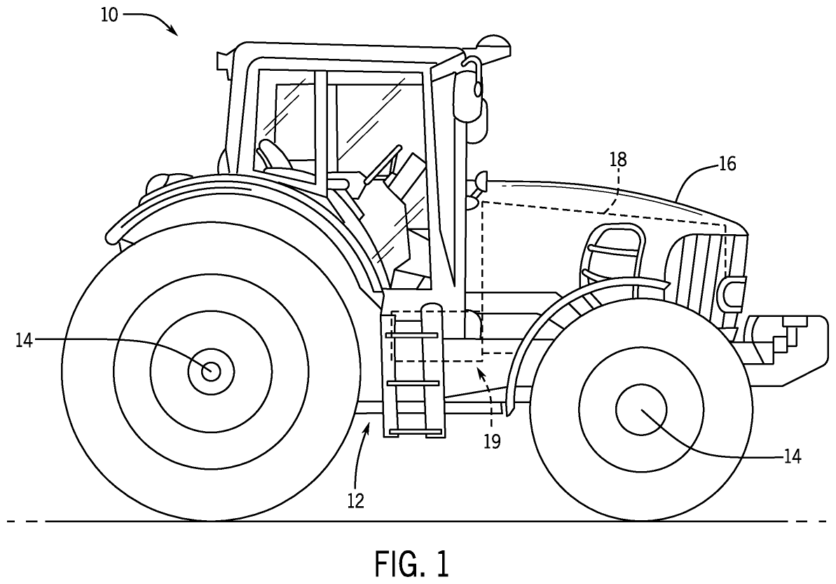

Example embodiments of an engine system having an EGR pump and intercooler will now be described in conjunction with FIGS. 1-3 according to this disclosure. The following examples notwithstanding, engine systems having internal combustion engines and turbocharger assemblies of other constructions would also benefit from an EGR pump and intercooler being incorporated therein according to aspects of the invention. It is therefore recognized that aspects of the invention are not meant to be limited only to the specific embodiments described hereafter.

### EXAMPLE EMBODIMENT(S) OF AN ENGINE SYSTEM WITH TURBOCHARGER INTERCOOLER AND EXHAUST GAS RECIRCULATION PUMP

According to embodiments, an engine system is disclosed that includes an EGR pump and intercooler that provide improved fuel efficiency and component longevity. As will become apparent to those skilled in the art from the following description, the engine system finds particular applicability in compression ignition diesel engines that are used in a work vehicle, and therefore the illustrative examples discussed herein utilize such an environment to aid in the understanding of the invention.

Referring initially to FIG. 1, a work vehicle 10 is shown that can implement embodiments of the invention. In the illustrated example, the work vehicle 10 is depicted as an agricultural tractor. It will be understood, however, that other configurations may be possible, including configurations with the work vehicle 10 as a different kind of tractor, a harvester, a log skidder, a grader, or one of various other work vehicle types. The work vehicle 10 includes a chassis or frame 12 carried on front and rear wheels 14. Positioned on a forward end region of the chassis 12 is a casing 16 within which is located an engine system 18. The engine system 18 provides power via an associated powertrain 19 to an output member (e.g., an output shaft, not shown) that, in turn, transmits power to axle(s) of the work vehicle 10 to provide propulsion thereto and/or to a power take-off shaft for powering an implement on or associated with the work vehicle 10, for example.

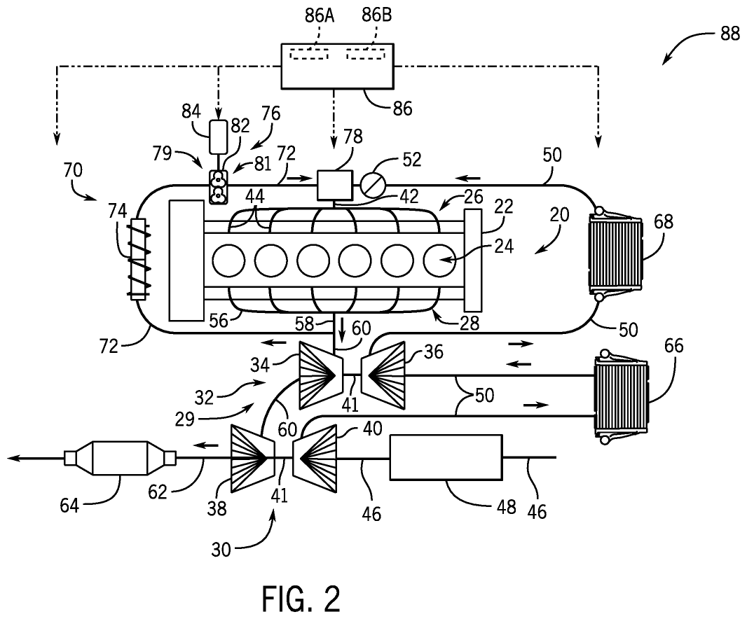

The engine system 18 is illustrated in greater detail in FIG. 2 in accordance with an example implementation. The engine system 18 includes an internal combustion engine 20 (hereafter, “engine”) that, in different embodiments, may be a gasoline powered or diesel-powered engine. The engine 20 of the engine system 18 includes an engine block 22 having a plurality of piston-cylinder arrangements 24 therein that generate combustion events during engine operation. In the illustrated implementation, the engine 20 is an inline-6 (I-6) engine defining six piston-cylinder arrangements 24; however, in alternative implementations, various engine styles and layouts may be used.

The engine system 18 also includes an intake manifold 26 fluidly connected to the engine 20, an exhaust manifold 28 fluidly connected to the engine 20, and a turbocharger assembly 29 that includes a pair of series-connected turbochargers 30, 32 fluidly connected to and in operable communication with the intake manifold 26 and the exhaust manifold 28. The turbocharger assembly 29 includes a low-pressure (LP) turbocharger 30 and a high-pressure (HP) turbocharger 32 arranged in series—with each of the turbochargers 30, 32 including a turbine 34, 38 and a compressor 36, 40 mechanically connected via a rotatable shaft 41. In operation of each of the turbochargers 30, 32, exhaust gas flowing through the turbine 34, 38 causes the turbine to rotate, thereby causing the shaft 41 to rotate. Rotation of the shaft 41, in turn, causes the compressor 36, 40, to also rotate, which draws additional air into the compressors 36, 40 to thereby increase the flow rate of air to the intake manifold 26 above what it would otherwise be without the turbochargers 30, 32, and in this manner the turbochargers 30, 32 supply so-called “charge” air to the engine 20. In an embodiment, one or both of the turbochargers 30, 32 could be configured as an electric turbocharger (e-turbocharger) that also includes an electric motor (not shown) that provides rotational power to the shaft 41 to drive the respective compressor 36, 40 to further boost the charge air output therefrom.

As indicated, the HP and LP turbochargers 32, 30 are arranged in series with one another. The HP turbocharger 32 features a turbine 34 (HP turbine) for receiving exhaust gas from the exhaust manifold 28 and a compressor 36 (HP compressor) coupled to the HP turbine 34 for delivering pressurized air to the intake manifold 26 for combustion. The LP turbocharger 30 features a turbine 38 (LP turbine) for receiving exhaust gas from the HP turbine 34 and a compressor 40 (LP compressor) coupled to the LP turbine 38 for delivering pressurized air to the HP compressor 36 for further pressurization. Both the LP and HP turbochargers 30, 32, function to recover a portion of heat energy from the exhaust gas with their respective turbines 34, 38, to drive their respective compressors 36, 40 and thereby increase the amount of intake or “charge” air delivered to the engine 20 for combustion. In other engines, the turbocharger assembly 29 may contain a plurality of HP turbos 32 and/or LP turbos 30, such as in a work vehicle 10 utilizing a V-engine with two HP turbos 32 (one per engine bank) and having adjoining HP turbo outlet pipes prior to flowing exhaust gases into the LP turbo 30.

As shown in FIG. 2, the intake manifold 26 includes a main intake 42 and a plurality of secondary pipes 44, with each of the secondary pipes 44 in fluid communication with a corresponding piston-cylinder arrangement 24 to direct a supply of air thereto. Fresh air is provided to the intake manifold 26 from the ambient environment via a fresh air intake passageway 46. Fresh air is drawn into the fresh air intake passageway 46, passed through an air filter 48 disposed in-line with the fresh air intake passageway 46, and provided to the LP compressor 40. The LP compressor 40 performs a first compression to the fresh air and provides it to the HP compressor 36 via a charge air passageway 50. The charge air passageway 50 then runs from the HP compressor 36 to the intake manifold 26 to provide compressed charge air from the HP compressor 36, with an air throttle 52 positioned in the charge air passageway 50 to regulate the amount of compressed charge air provided to the intake manifold 26.

The exhaust manifold 28 of the engine system 18 includes a plurality of secondary pipes 56, each in fluid communication with a corresponding piston-cylinder arrangement 24, that direct exhaust gases generated by the engine 20 to a main outlet 58. The exhaust manifold 28 is fluidly coupled to inlets of the turbines 34, 38 of the turbochargers 30, 32 via an exhaust gas passageway 60, with fluid outlets of the turbines 34, 38 then fluidly coupled to the ambient environment via a vent passageway 62. Exhaust gas produced by the engine 20 is directed out from the exhaust manifold 28 and passes through the exhaust gas passageway 60 to the turbines 34, 38, with the exhaust gas then exiting the turbines 34, 38 to the ambient environment via the vent passageway 62 in a conventional manner. An aftertreatment system 64 may be disposed in-line with the vent passageway 62 to treat the exhaust gas prior to the exhaust gas being vented to ambient, such as by performing a diesel oxidation catalyzation, diesel particulate filtration (DPF) regeneration, or selective catalyst reduction, for example.

Also included in the engine system 18 are a pair of charge air coolers 66, 68 positioned in-line with the charge air passageway 50 that function to reduce the temperature of the charge air prior to it being provided to the engine 20, so as to increase the unit mass per unit volume (i.e., density) of the charge air for improved volumetric efficiency. The charge air coolers include an intercooler 66 positioned between the LP compressor 40 and HP compressor 36 and an aftercooler 68 positioned downstream from the HP compressor 36. The intercooler 66 removes waste heat from the first stage of compression performed by the LP compressor 40 to densify the charge air and thereby allow the HP compressor 36 to subsequently compress the charge air more efficiently at a lower temperature. The aftercooler 68 removes waste heat from the second stage of compression performed by the HP compressor 36 to reduce the temperature of the charge air and provide a denser intake charge to the engine 20 to allow more air and fuel to be combusted per engine cycle, increasing the output of the engine 20. According to an example embodiment, the intercooler 66 and aftercooler 68 are configured as air-air heat exchangers that reject the waste heat generated from compression using ambient air flowing through the heat exchanger. However, in an alternate embodiment, the intercooler 66 and aftercooler 68 could instead be configured as liquid-air heat exchangers that transfer waste heat from the charge air to an intermediate liquid (e.g., water), which finally rejects the heat to the ambient air.

An exhaust gas recirculation (EGR) system 70 is further provided in the engine system 18 that functions to recirculate a portion of the exhaust gas generated by the engine 20 and thereby reduce the formation of NOx during combustion. Exhaust gas is drawn from the exhaust manifold 28 and recirculated into the intake manifold 26 via the EGR system 70. The EGR system 70 includes an EGR passageway 72, an EGR cooler 74, an EGR pump 76, and an EGR mixer 78. The EGR passageway 72 draws in a portion of the exhaust gas that is flowing within the exhaust gas passageway 60 for circulation through the EGR system 70. The EGR cooler 74 is disposed in-line with the EGR passageway 72 for the purpose of cooling the exhaust gas flowing through the EGR passageway 72 and, in one embodiment, is configured as liquid-air heat exchanger that transfers heat from the exhaust gas to an intermediate liquid (e.g., water), which finally rejects the heat to the ambient air. Exhaust gas that flows through the EGR cooler 74 proceeds downstream to the EGR pump 76, with the EGR pump 76 having an inlet side 79 in fluid communication with the exhaust manifold 28 and an outlet side 81 in fluid communication with the intake manifold 26. Positioning the EGR pump 76 downstream of the EGR cooler 74 will help to reduce the thermal exhaust energy acting on the EGR pump; however, in an alternate embodiment, the EGR pump 76 could be upstream of the EGR cooler 74 (i.e., a hot side EGR pump 76). In one embodiment, the EGR pump 76 is constructed to include a compressor 82 driven by an electric motor 84. The compressor 82 of the EGR pump 76 may be a positive-displacement type compressor capable of delivering physically metered air flowrates, such as a roots, screw, scroll, or vane compressor, or alternatively may be a radial-type compressor similar to a turbocharger compressor.

The EGR pump 76 may be electrically controlled to selectively control the flow of exhaust gas recirculated from the exhaust gas passageway 60 to the engine 20 via the EGR passageway 72, including cutting off the flow of exhaust gas therethrough and selectively restricting or controlling the flow of exhaust gas therethrough by a desired amount. For providing such electrical control, a controller 86 is included in the engine system to control operation of the EGR pump 76. The controller 86 may be configured as one or more computing devices with associated processor devices 86(a) and memory architectures 86(b). The controller 86 may be a dedicated controller that only operates EGR pump 76 or, in some embodiments, may be provided as an engine control unit (ECU) operable to also control overall operation of the engine system 18, including the engine 20, and turbochargers 30, 32, and other actuators, valves, etc. in the engine system 18, for example, with the controller 86 configured to execute various computational and control functionality with respect to the engine system 18. In controlling operation of the EGR pump 76, the electric motor 84 of the EGR pump 76 may receive control signals from the controller 86 that cause the electric motor 84 to control the speed and/or displacement of the compressor 82, thereby providing for metering of exhaust gas quantities. A flow of exhaust gas may thus be output from the EGR pump 76 and provided to the EGR mixer 78, which intermixes the exhaust gas with the charge air provided from the charge air passageway 50 for introduction to the intake manifold 26, by which the mixed exhaust gas and charge air is then fed to the engine 20. In other implementations, a dedicated EGR mixer 78 may not be included in the engine system 18, with exhaust gas instead being introduced to induction piping of the engine 20 and/or the intake manifold 26 for mixing with the charge air.

As shown in FIG. 2, the EGR system 70 draws exhaust gas from the exhaust gas passageway 60 at a location upstream from the HP turbine 34. This drawing of exhaust gas from the exhaust gas passageway 60 upstream from the HP turbine 34 provides the EGR system 70 with exhaust gas having increased energy (i.e., pressure) as compared to if exhaust gas were drawn from the exhaust gas passageway 60 at a location downstream from the HP turbine 34, such as a location between the HP turbine 34 and LP turbine 38 or a location downstream from the LP turbine 38. The increased energy in the exhaust gas allows for the EGR pump 76 to operate at a lower power demand, as less work is required for the EGR pump 76 to bring the exhaust gas to a charge intake pressure, as necessary for mixing the exhaust gas and charge air and providing the mixed exhaust gas and charge air to the engine 20. Accordingly, the EGR system 70 (and engine system 18 overall) can operate at a higher efficiency as compared to if the EGR system 70 were configured to draw reduced-pressure exhaust gas from a location where the exhaust gas had already passed through one or both of the HP turbine 34 and LP turbine 38.

In recirculating exhaust gas from the exhaust manifold 28 back to the intake manifold 26, the EGR system 70 keeps the exhaust gas segregated from other portions of the engine system 18. Specifically, rather than directing (and mixing) the exhaust gas into the fresh air at a location along fresh air intake passageway 46 or charge air passageway 50 and upstream of one or both the LP compressor 40 and HP compressor 36 (and then compressing the mixture of the exhaust gas and fresh air with the compressor(s) 36, 40), the EGR system 70 recirculates the exhaust gas from the exhaust gas passageway 60 back directly to the intake manifold 26 (after mixing with the charge air in EGR mixer 78). This segregating of the recirculated exhaust gas from the HP and LP compressors 36, 40 provides a number of efficiency and longevity benefits for the engine system 18. First, by not running recirculated exhaust gas through one or more of the HP and LP compressors 36, 40, the amount of fresh intake air (i.e., mass flow rate of intake air) run through the compressor(s) 36, 40 can be maintained at a desired level that “matches” the compressor(s) 36, 40 with the engine 20, with power and efficiency benefits for compressor operation being derived from controlling the flow rate therethrough as compared to additional work and power that would be required by the compressor(s) 36, 40 to compress a combined flow of exhaust gas and fresh intake air. For example, the HP and LP compressors 36, 40 could operate with improved power and efficiency when handling an air flow of 100 units of fresh intake air therethrough as compared to handling an air flow of 130 units of a mixture of exhaust gas and fresh intake air therethrough. Second, by not running recirculated exhaust gas through one or more of the HP and LP compressors 36, 40, the compressors 36, 40 are not exposed to the water vapor, acids, and soot (particulates) that is present in the exhaust gas, thereby reducing the likelihood of corrosion in the compressors 36, 40. That is, under certain temperatures, the presence of exhaust gas in the compressors 36, 40 may cause the water vapor to condense and pool therein, and the mixture of this water with acid and soot that accumulate on the compressor components can lead to corrosion of these components.

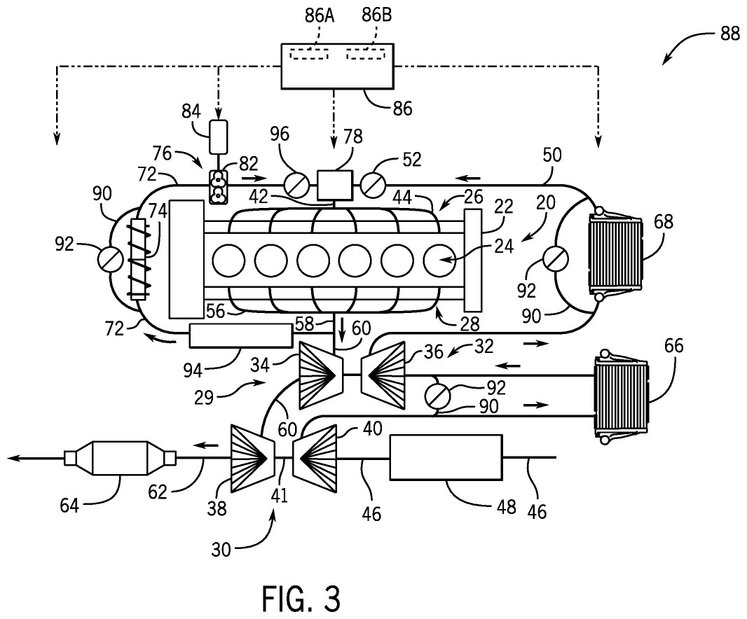

Referring now to FIG. 3, an engine system 88 is illustrated according to another embodiment. The engine system 88 includes many common components as the engine system 18 of FIG. 2, and thus common components of the engine system 88 are identified consistent with those in FIG. 2, but FIG. 3 includes additional components or features that are envisioned as being included in the engine system 88.

As previously described, the engine system 88 includes an intercooler 66 and an aftercooler 68 positioned in-line with the charge air passageway 50 that function to reduce the temperature of the charge air prior to it being provided to the engine 20, so as to increase the unit mass per unit volume (i.e., density) of the charge air for improved volumetric efficiency. The intercooler 66 is positioned between the LP compressor 40 and HP compressor 36 and removes waste heat from the first stage of compression performed by the LP compressor 40 to densify the charge air and thereby allow the HP compressor 36 to subsequently compress the charge air more efficiently at a lower temperature, while the aftercooler 68 is positioned downstream from the HP compressor 36 and removes waste heat from the second stage of compression performed by the HP compressor 36 to reduce the temperature of the charge air and provide a denser intake charge to the engine 20 to allow more air and fuel to be combusted per engine cycle, increasing the output of the engine 20.

As shown in FIG. 3, bypass passageways 90 and associated bypass valves 92 are provided that allow for charge air to bypass one or more of the intercooler 66, aftercooler 68, and EGR cooler 74. In certain operating modes or in certain operating environments, such as during engine start-up or during operation in a cold environment, it may not be desirable to cool charge air after it has undergone compression in the LP compressor 40 and/or HP compressor 36 and/or exhaust gas as it is recirculated through the EGR system 70, as the engine system 88 can require exhaust gas at a certain temperature in order to ensure proper aftertreatment of the exhaust gas to reduce harmful emissions from the engine system 88. In such situations, the valves 92 in bypass passageways 90 may be actuated to an open position to allow charge air to flow through the valves 92 and bypass the intercooler 66, aftercooler 68, and/or EGR cooler 74. Accordingly, exhaust gas provided to the aftertreatment system 64 may be kept at a higher temperature so as to allow for proper treatment thereof.

In the engine system 88, other additional components are included in the EGR system 70—with an EGR filter 94 and EGR valve 96 being provided therein. The EGR filter 94 is positioned upstream from the EGR cooler 74 and acts to filter our particulates or soot from the exhaust gas drawn into the EGR passageway 72. Removal of particulates or soot from the exhaust gas can increase the longevity of the EGR cooler 74 and EGR pump 76 by preventing build-up of such particulates or soot therein. The EGR valve 96 is positioned downstream of the EGR pump 76 and acts to provide a more complete seal in the EGR passageway 72 that prevents leakage of exhaust gas, which may be desired in situations where EGR is not desired. That is, it is recognized that the structure of the EGR pump 76, including the housing and rotors (not shown) contained therein, may allow for some leakage of exhaust gas through the EGR pump 76, and thus the EGR valve 96 may be provided in the EGR passageway 72 to prevent such leakage of exhaust gas. In additional implementations, the EGR valve 96 may be positioned in other places within the EGR system 70, such as upstream of the EGR pump 76, upstream of EGR cooler 74, or upstream of the EGR filter 94.

Desirably, embodiments of the engine system 18, 88 described herein provide an efficient means by which to boost fuel efficiency and increase system longevity. The EGR system 70 in the engine system 18, 88 draws exhaust gas from a location upstream from the turbocharger turbines, i.e., upstream from both the HP and LP turbines 34, 38, for recirculation through the EGR system 70. The exhaust gas drawn into the EGR system 70 therefore has a higher pressure (as compared to exhaust gas that could be drawn into the EGR system 70 after having passed through one or both of the HP and LP turbines 34, 38) that allows for the EGR pump 76 to operate at a lower power demand, as less work is required for the EGR pump 76 to bring the exhaust gas to an intake charge pressure for mixing the with the charge air and being provided to the engine 20. Additionally, as the exhaust gas recirculated through the EGR system 70 is kept segregated from the fresh intake air that passes through the LP and HP compressors 40, 36, the flow rate of fresh intake air through the LP and HP compressors 40, 36 can be better controlled to optimize power and efficiency in operating the compressors, and the LP and HP compressors 40, 36 and inter- and aftercoolers 66, 68 can be better maintained by not exposing them to the water vapor, acids, and soot (particulates) that is present in the exhaust gas, thereby reducing the likelihood of corrosion in the compressors and coolers and increasing the longevity thereof.

Beneficially, the inclusion of the EGR pump 76, the intercooler 66, and the aftercooler 68 in the engine system 18, 88 as previously described—and the synergistic operation of these components in combination with each other—provide for improved BSFC, or fuel efficiency, in the engine system 18, 88. The inclusion of the intercooler 66 and aftercooler 68 in the engine system 18, 88 provides for a denser intake charge to the engine 20 to allow more air and fuel to be combusted per engine cycle, increasing the volumetric efficiency and output of the engine 20, while the inclusion of the EGR pump 76 negates the requirement for a set pressure relationship between the charge air and the exhaust gas and thereby allows for use of higher efficiency turbines 34, 38 in the HP and LP turbochargers 32, 30. The synergistic operation of the EGR pump 76, the intercooler 66, and the aftercooler 68, thereby provides an improvement in the range of 4% in BSFC in the engine system 18, 88 over engine systems that do not utilize an EGR pump 76 and/or dual-stage cooling arrangement with an intercooler 66.

### ENUMERATED EXAMPLES

The following examples are provided, which are numbered for ease of reference.

1. An internal combustion engine system includes an engine block having one or more piston-cylinder arrangements communicating with an intake manifold and an exhaust manifold, a high-pressure (HP) turbocharger including an HP turbine in communication with the exhaust manifold and including an HP compressor in communication with the intake manifold, a low-pressure (LP) turbocharger including an LP turbine in communication with the exhaust manifold via the HP turbine and including an LP compressor in communication with the intake manifold via the HP compressor, an exhaust gas recirculation (EGR) system including an EGR pump upstream of the HP turbine and in communication with the exhaust manifold at an inlet side of the EGR pump and in communication with the intake manifold at an outlet side of the EGR pump, and an intercooler interposed between the LP compressor and the HP compressor.

2. The internal combustion engine system of example 1, wherein the EGR system includes an EGR cooler, with the EGR cooler and the EGR pump upstream of the HP turbine.

3. The engine system of example 2, wherein the EGR cooler is a liquid-air heat exchanger.

4. The internal combustion engine system of example 2, wherein the EGR system includes an EGR filter upstream of the EGR cooler and the EGR pump.

5. The internal combustion engine system of claim 1, wherein the intercooler is an air-air heat exchanger.

6. The internal combustion engine system of example 1, further including an aftercooler downstream of the HP compressor and in communication with the intake manifold.

7. The internal combustion engine system of example 6, wherein the aftercooler is an air-air heat exchanger.

8. The internal combustion engine system of example 1, wherein the EGR system includes an EGR valve downstream or upstream of the EGR pump and upstream of the intake manifold.

9. The internal combustion engine system of example 1, further including an aftertreatment system downstream of the LP turbine.

10. An internal combustion engine system includes an engine block having one or more piston-cylinder arrangements communicating with an intake manifold and an exhaust manifold, a high-pressure (HP) turbocharger including an HP turbine in communication with the exhaust manifold and including an HP compressor in communication with the intake manifold, a low-pressure (LP) turbocharger including an LP turbine in communication with the exhaust manifold via the HP turbine and including an LP compressor in communication with the intake manifold via the HP compressor, an exhaust gas recirculation (EGR) system including an EGR pump upstream of the HP turbine and in communication with the exhaust manifold at an inlet side of the EGR pump and in communication with the intake manifold at an outlet side of the EGR pump, an intercooler interposed between the LP compressor and the HP compressor, and an aftercooler downstream of the HP compressor and in communication with the intake manifold.

11. The internal combustion engine system of example 10, wherein the EGR system includes an EGR cooler, with the EGR cooler and the EGR pump upstream of the HP turbine.

12. The internal combustion engine system of example 11, wherein the EGR system includes an EGR filter upstream of the EGR cooler and the EGR pump.

13. The internal combustion engine system of example 10, wherein the EGR cooler is a liquid-air heat exchanger.

14. The internal combustion engine system of example 10, wherein each of the intercooler and the aftercooler is an air-air heat exchanger.

15. The internal combustion engine system of example 10, wherein the EGR system includes an EGR valve downstream of the EGR pump and upstream of the intake manifold.

### CONCLUSION

The foregoing has thus provided an engine system that includes an EGR system and intercooler arrangement that provides for improved fuel efficiency and component longevity. The EGR system is segregated from the turbocharger assembly and associated interstage cooler and aftercooler included in the engine system. An EGR pump included in the EGR system directs a portion of the exhaust gas produced by the engine directly back to the engine intake without being routed through the turbochargers and associated coolers in the engine system. The EGR pump draws exhaust gas from a location upstream of the HP turbocharger, so that the amount of work performed by the EGR pump is reduced in bringing the exhaust gas to a pressure that matches that of the intake air provided to the engine.

As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

1. An internal combustion engine system comprising:
an engine comprising a gasoline-powered or diesel-powered engine, the engine including an engine block having one or more piston-cylinder arrangements communicating with an intake manifold and an exhaust manifold, with all exhaust gas generated by the engine provided to a common output of the exhaust manifold;
a high-pressure (HP) turbocharger including an HP turbine in communication with the common output of the exhaust manifold and including an HP compressor in communication with the intake manifold;
a low-pressure (LP) turbocharger including an LP turbine in communication with the exhaust manifold via the HP turbine and including an LP compressor in communication with the intake manifold via the HP compressor;
an exhaust gas recirculation (EGR) system including an EGR pump upstream of the HP turbine and in communication with the common output of the exhaust manifold at an inlet side of the EGR pump and in communication with the intake manifold at an outlet side of the EGR pump; and
an intercooler interposed between the LP compressor and the HP compressor.

2. The internal combustion engine system of claim 1, wherein the EGR system includes an EGR cooler, with the EGR cooler and the EGR pump upstream of the HP turbine.

3. The internal combustion engine system of claim 2, wherein the EGR cooler is a liquid-air heat exchanger.

4. The internal combustion engine system of claim 2, wherein the EGR system includes an EGR filter upstream of the EGR cooler and the EGR pump.

5. The internal combustion engine system of claim 1, wherein the intercooler is an air-air heat exchanger.

6. The internal combustion engine system of claim 1, further including an aftercooler downstream of the HP compressor and in communication with the intake manifold.

7. The internal combustion engine system of claim 6, wherein the aftercooler is an air-air heat exchanger.

8. The internal combustion engine system of claim 1, wherein the EGR system includes an EGR valve downstream or upstream of the EGR pump and upstream of the intake manifold.

9. The internal combustion engine system of claim 1, further including an aftertreatment system downstream of the LP turbine.

10. An internal combustion engine system comprising:
an engine comprising a gasoline-powered or diesel-powered engine, the engine including an engine block having one or more piston-cylinder arrangements communicating with an intake manifold and an exhaust manifold, with all exhaust gas generated by the engine provided to a common output of the exhaust manifold;
a high-pressure (HP) turbocharger including an HP turbine in communication with the common output of the exhaust manifold and including an HP compressor in communication with the intake manifold;
a low-pressure (LP) turbocharger including an LP turbine in communication with the common output of the exhaust manifold via the HP turbine and including an LP compressor in communication with the intake manifold via the HP compressor;
an exhaust gas recirculation (EGR) system including an EGR pump upstream of the HP turbine and in communication with the common output of the exhaust manifold at an inlet side of the EGR pump and in communication with the intake manifold at an outlet side of the EGR pump;
an intercooler interposed between the LP compressor and the HP compressor; and
an aftercooler downstream of the HP compressor and in communication with the intake manifold.

11. The internal combustion engine system of claim 10, wherein the EGR system includes an EGR cooler, with the EGR cooler and the EGR pump upstream of the HP turbine;
wherein the EGR cooler is a liquid-air heat exchanger; and
wherein the EGR system includes an EGR filter upstream of the EGR cooler and the EGR pump.

12. (canceled)

13. (canceled)

14. The internal combustion engine system of claim 10, wherein the intercooler is an air-air heat exchanger.

15. The internal combustion engine system of claim 10, wherein the aftercooler is an air-air heat exchanger.

16. The internal combustion engine system of claim 10, wherein the EGR system includes an EGR valve downstream or upstream of the EGR pump and upstream of the intake manifold.

17. (canceled)

18. An internal combustion engine system comprising:
an engine comprising a gasoline-powered or diesel-powered engine, the engine including an engine block having one or more piston-cylinder arrangements communicating with an intake manifold and an exhaust manifold, with all exhaust gas generated by the engine provided to a common output of the exhaust manifold;
a high-pressure (HP) turbocharger including a HP turbine in communication with the common output of the exhaust manifold and including a HP compressor in communication with the intake manifold;
a low-pressure (LP) turbocharger including a LP turbine in communication with the common output of the exhaust manifold via the HP turbine and including a LP compressor in communication with the intake manifold via the HP compressor;
an exhaust gas recirculation (EGR) system including:
an EGR pump upstream of the HP turbine and in communication with the common output of the exhaust manifold at an inlet side of the EGR pump and in communication with the intake manifold at an outlet side of the EGR pump; and
an EGR cooler upstream of the HP turbine;
an intercooler interposed between the LP compressor and the HP compressor; and
an aftercooler downstream of the HP compressor and in communication with the intake manifold.

19. The internal combustion engine system of claim 18, wherein the EGR system further includes:
an EGR valve downstream or upstream of the EGR pump and upstream of the intake manifold; and
an EGR filter upstream of the HP turbine and upstream of the EGR cooler.

20. The internal combustion engine system of claim 18, wherein the EGR cooler is a liquid-air heat exchanger;
wherein the intercooler is an air-air heat exchanger; and
wherein the aftercooler is an air-air heat exchanger.

21. The internal combustion engine system of claim 1, further comprising an intercooler bypass passage having an intercooler bypass valve therein, the intercooler bypass valve being actuatable to an open position to allow air output from the LP compressor to flow through the intercooler bypass passage and bypass the intercooler.

22. The internal combustion engine system of claim 6, further comprising an aftercooler bypass passage having an aftercooler bypass valve therein, the aftercooler bypass valve being actuatable to an open position to allow air output from the HP compressor to flow through the aftercooler bypass passage and bypass the aftercooler.

23. The internal combustion engine system of claim 2, further comprising an EGR cooler bypass passage having a bypass valve therein, the bypass valve being actuatable to an open position to allow the exhaust gas in the EGR system to flow through the EGR cooler bypass passage and bypass the EGR cooler.
